(19) United States
(12) Patent Application Publication
(10) Pub. No.: US 2003/0153447 A1
(43) Pub. Date: Aug. 14, 2003

(54) Tag attaching apparatus

(76) Inventors: Paul M. Block, Nesconset, NY (US); Steven J. Kunreuther, New York, NY (US)

Correspondence Address: JAMES & FRANKLIN, LLP, Suite 1217, 60 East 42nd Street, New York, NY, 10165, US

(21) Appl. No.: 10/073,089

(22) Filed: Feb. 12, 2002

(51) Int. Cl. B31B 1/90

(52) U.S. Cl. 493/376

(57) ABSTRACT

Tags are removed from a hopper one at a time and transported by a moveable carriage, carrying a rotatable vacuum arm with a suction cup, onto a tag support platform. The arm moves the tag through an arcuate path section to a plane parallel to the plane of the support platform and then through a linear path section into alignment with the support platform. The tag is clamped to the top surface of the tag support platform. The article to be tagged is placed between the undersurface of the tag support platform and an anvil. The anvil moves up to hold the article against the underside of the tag support platform. The fastener dispensing device is moved toward the tag support platform such that the needle passes through an opening in the tag and penetrates the article. The fastener is ejected to attach the tag to the article. The hopper is independently position adjustable horizontally and vertically. A laser facilitates positioning of the hopper. The vacuum arm is keyed to the carriage such that the suction cup is always coplanar with the lead tag in the hopper, when the tag is engaged.

The present invention relates to apparatus for automatically attaching tags of various types to articles and more particularly to an improved apparatus for automatically attaching such tags.

Tags of various types are utilized to label large quantities of many different types of articles, such as clothing. One popular means of attaching tags to articles is by using plastic fasteners. Such fasteners are provided with a T-bar at one end. The T-bar is connected to an enlarged paddle, located at the other end of the fastener, by a thin, flexible filament. The filament is stretched during the fabrication process to give it a high tensile strength.

To attach the fastener, a fastener dispensing device with a gun-like housing having a protruding hollow slotted metal needle is utilized. The needle is inserted through a pre-punched opening in the tag and penetrates the article to be tagged. The T-bar end of the fastener is then ejected through the needle, such that the T-bar is situated on one side of the tag and article, with the enlarged paddle end on the other side, anchoring the tag to the article.

Hand held fastener dispensing devices of this type are used widely and commercially available from a number of suppliers. Those devices may be manually operated or power driven, either electrically or pneumatically. Table mounted versions are also commonly utilized, sometimes in conjunction with automatic tag feeding mechanisms. Circuitry for controlling the tag feed and fastener dispensing operations is provided. See, for example, U.S. Pat. No. 3,896,713 entitled “Top-Feeding Automatic Tag-Attaching Machine” issued to Mato on Jul. 29, 1975 and U.S. Pat. No. 4,235,161 entitled “Automatic Tag Attaching Apparatus” issued to Kunreuther on Nov. 25, 1980 and U.S. Pat. No. 4,718,158 entitled “Automatic Tagging Apparatus and Method Therefor” issued to Charles Block on Jan. 12, 1988.

Some automatic tagging mechanisms available currently, such as those mentioned in the previous paragraph, employ a tag feed system including a pneumatically driven reciprocating slide mechanism. The slide moves tags, one at a time, from a hopper to a position where the pre-punched opening in the tag is aligned with the needle of the fastener dispensing device. The fastener dispensing device is then advanced to insert the needle through the tag opening.

Other automatic tagging mechanisms utilize a stationary fastener dispensing device. A vacuum arm with a suction cup transports tags from the hopper and places the tag directly on the needle of the fastener dispensing device. See U.S. Pat. No. 4,781,318 entitled “Tagging Apparatus” issued to R. Meyers on Nov. 1, 1988. In the Meyers' apparatus, the arm vacuum must be moved thorough a sinuous path that ends in a path section which is parallel to needle of the fastener dispensing device in order for the needle to be received in the tag opening.

The above automatic tag feed systems require precise adjustment of the vertical and horizontal position of the tag hopper relative to the tag transport means because the opening in the tag is relatively small and the tag must be positioned such that the tag opening aligns exactly with the needle. Because of this, the set up of the machine is time consuming. Each time different size tags are used, readjustment of the hopper position is necessary, requiring considerable machine down time.

In the apparatus with vacuum-type transport means, vacuum as well as electrical power are needed. Further, in a hostile environment, it has been found that tag feeders of this type do not always operate reliably.

The present invention is an improvement over current automatic tag attaching apparatus in several important respects. It includes a vacuum-type tag transport mechanism with an arm which moves an engaged tag through a simplified path of travel onto a stationary tag support platform. The fastener dispenser then is advanced toward the tag support platform to insert the needle through the tag opening. The tag hopper is independently position adjustable in horizontal and vertical directions. A laser light is used to facilitate positioning of the hopper such that the tag is placed on the tag support platform with the opening in alignment with the needle. The vacuum arm is keyed to the transport mechanism to insure the suction cup on the vacuum arm is coplanar with the lead tag in the hopper, when the tag is engaged. These improvements greatly facilitate machine set up and reduce down time. Separately actuable and operable tag clamping and article holding systems allow the tag to be clamped to the support platform before the article is placed in the apparatus, making the apparatus easy to operate.

It is therefore a prime object of the present invention to provide an improved automatic tag attaching apparatus which is easy to set up and to operate.

It is another object of the present invention to provide an improved automatic tag attaching apparatus which includes a tag hopper which is independently position adjustable in horizontal and vertical directions.

It is another object of the present invention to provide an improved automatic tag attaching apparatus which includes a laser light for positioning the hopper.

It is another object of the present invention to provide an improved automatic tag attaching apparatus which includes a vacuum arm which moves a tag from the hopper, through an arcuate path section to a plane perpendicular to the needle, and then a path section along the perpendicular plane, into alignment with the tag support platform.

It is another object of the present invention to provide an improved automatic tag attaching of the apparatus which clamps a tag to one side of the tag support platform and holds the article to be tagged to the opposite side of the tag support platform.

It is another object of the present invention to provide an improved automatic tag attaching apparatus which includes a moveable anvil for holding an article in place while the fastener dispensing device is advanced such that the needle passes through the tag opening and penetrates the article.

It is another object of the present invention to provide an improved automatic tag attaching apparatus wherein the vacuum arm is keyed to the transport mechanism to insure that the suction cup is coplanar with the lead tag in the hopper, when the tag is engaged.

In accordance with one aspect of the present invention, automatic tag attaching apparatus is provided including means for holding a plurality of tags and tag support means spaced from the tag holding means. Vacuum tag transport means removes tags, one at a time, from the tag holding means and places them on the tag support means. Means are provided for clamping the tag on the tag support means. The article to be tagged is situated proximate the tag support platform. Fastener dispensing means include a hollow needle through which fasteners are ejected. Means are provided for moving the fastener dispensing means relative to the tag support means to cause the needle to pass through the clamped tag and held article. Means are also provided for actuating the fastener ejecting means.

The anvil means includes a needle receiving recess. It is situated normally spaced from the tag support means. Means are provided for advancing the anvil towards the tag support platform to hold the article to be tagged therebetween. The anvil advancing means is actuated before the fastener dispensing means.

The tag transport means moves a tag through a first path section, wherein the tag is moved to a plane substantially perpendicular to the needle and then through a second path section, wherein the tag is moved substantially within that perpendicular plane, into alignment with the tag support means.

The tag transport means comprises a linearly moveable carriage, an arm with a suction cup and means for rotatably mounting the arm on the carriage. The arm mounting means includes means for keying the arm to the carriage such that the suction cup is coplanar with the lead tag in the tag holding means, when the tag is engaged by the suction cup.

The apparatus comprises a work surface. Means are provided for position adjustably mounting the tag holding means on the work surface for independent positioning in two directions, horizontally and vertically.

In accordance with another aspect of the present invention, automatic tag attaching apparatus are provided including means for holding a plurality of tags and tag support means spaced from the tag holding means. Tag transport means removes tags, one at a time, from the tag holding means and places them on the tag support means. Fastener dispensing means are provided with a hollow needle through which fasteners are ejected. Means are provided for moving the fastener dispensing means relative to the tag support means to cause the needle to pass through the tag on the tag support means. Means are provided for actuating the fastener dispensing means. The tag transport means includes means adapted to engage a tag in the tag holding means. Means are provided for moving the tag engaging means through a first path section, wherein the engaged tag is situated in a plane substantially perpendicular to the needle and then through a second path section, wherein the engaged tag is moved along that perpendicular plane, into alignment with the tag support means.

The fastener dispensing means moves in a direction perpendicular to the plane of the tag support means. The tag support means is situated in a plane perpendicular to the needle. The second path section is parallel to the plane of the tag support means.

The tag transport means comprises a carriage, an arm upon which the tag engaging means is situated, and means for rotatably mounting the arm on the carriage. The arm mounting means includes means for keying the arm to the carriage such that the tag engaging means is coplanar with the lead tag in the tag holding means, when the tag is engaged.

The tag engaging means comprises a suction cup. The suction cup is mounted on the arm.

The apparatus also includes a work surface. Means are provided for position adjustably mounting the tag holding means on the work surface for independent positioning in two directions. Laser means for positioning the tag holding means mounting means is also provided.

In accordance with another aspect of the present invention, automatic tag attaching apparatus is provided including a work surface. Means, mounted on the work surface, holds a plurality of tags. Tag support means are spaced from the tag holding means. Tag transport means removes tags, one at a time, from the tag holding means and places them on the tag support means. Fastener dispensing means are provided with a hollow needle through which fasteners are ejected. Means are provided for moving the fastener dispensing means relative to the tag support means to cause the needle to pass through the tag on the tag support means. Means are provided for actuating the fastener dispensing means, as are means for mounting the tag holding means on the work surface for independent position adjustment in two directions relative to the work surface.

The tag holding means mounting means mounts the tag holding means for movement in a direction parallel to the work surface (horizontal) and in a direction perpendicular to the work surface (vertical). A rack is provided on the tag holding means. The rack is engaged by a pinion gear rotatably mounted on the work surface to move the tag holding means parallel to the work surface. A threaded shaft extending perpendicular to the work surface is provided. An internally threaded part connected to the tag holding means is rotatably received on the shaft to move the tag holding means in a direction perpendicular to the work surface.

The fastener dispensing means moving means moves the fastener dispensing means in one of two directions (vertical). The tag transport means moves a tag in the other of the two directions (horizontal).

The tag transport means moves a tag through a first path section, wherein the tag is situated in a plane substantially perpendicular to the needle and then through a second path section, wherein the tag is moved substantially within that perpendicular plane, into alignment with the tag support means.

Laser means are provided for positioning the tag holding means. The laser mans includes a laser light mounted in the work surface.

The tag transport means includes a linearly moveable carriage and an arm with a suction cup. Means are provided for rotatably mounting the arm to the carriage.

In accordance with another aspect of the present invention, automatic apparatus for attaching tags to articles is provided means for including holding a plurality of tags. Tag support means are spaced from the tag holding means. Tag transport means remove tags, one at a time, from the tag holding means and place them on the tag support means. Fastener dispensing means are provided, including a hollow needle through which fasteners are ejected. Means are provided for moving the fastener dispensing means relative to the tag support means to cause the needle to pass through the tag on the tag support means. Means are provided for actuating the fastener dispensing means. The tag transport means includes a moveable carriage. An arm carrying a suction cup is adapted to engage a tag in the tag holding means. Means are provided for mounting the arm on the carriage such that the suction cup is coplanar with the lead tag in the tag holding means, when the tag is engaged by the suction cup.

The tag transport means moves a tag through a first path section, wherein the tag is situated in a plane substantially perpendicular to the needle and then through a second path section, wherein the tag is moved substantially within that perpendicular plane, into alignment with the tag support means.

The first path section is arcuate. It also includes a linear component. The second path section is only linear.

The tag transport means includes a linearly moveable carriage. The arm is rotatably mounted in the carriage.

The arm mounting means includes a shaft on the carriage and a bracket with an opening through which the shaft extends. The bracket supports the arm. The opening is defined in part by a protrusion. The shaft has a slot. The protrusion is received in the slot.

The apparatus further includes a work surface. Means are provided for position adjustably mounting the tag holding means on the work surface for independent positioning in two directions. Laser means for positioning the tag holding means relative to the work surface are also provided.

The tag transport means moves a tag through a first path section, wherein the tag is situated in a plane substantially perpendicular to the needle and then through a second path section, wherein the tag is moved substantially within that perpendicular plane, into alignment with said tag support means.

In accordance with another aspect of the present invention, automatic tag attaching apparatus is provided including a work surface, means, position adjustably mounted on the work surface, is provided for holding a plurality of tags. Each of the tags has an opening. Tag support means is spaced from the tag holding means. Tag transport means are provided for removing tags, one at a time, from the tag holding means and placing them on the tag support means. Fastener dispensing means are provided including a hollow needle through which fasteners are ejected. Means are provided for moving the fastener dispensing means relative to the tag support means to cause the needle to pass through the opening in the tag on the tag support means. Means are provided for actuating the fastener dispensing means. Laser means are provided for positioning the tag holding means relative to the work surface such that the transport means places each tag on the support means with the opening in the tag in alignment with the needle.

Means are provided for position adjustably mounting the tag holding means on the work surface for independent positioning in two directions.

The tag transport means moves a tag through a first path section, wherein the tag is situated in a plane substantially perpendicular to the needle. It then moves the tag through a second path section wherein the tag is moved substantially within that perpendicular plane, into alignment with said tag support means.

The first path section is arcuate Preferably, first path section has an arcuate and a linear component. The second path section is only linear.

The tag transport means comprises a linearly moveable carriage and an arm with a suction cup. Means are provided for rotatably mounting the arm on the carriage. The arm mounting means comprises means for keying the arm to the carriage such that the suction cup is coplanar with the lead tag in the tag holding means, when the tag is engaged by the suction cup.

To these and to such other objects which may hereinafter appear, the present invention relates to an improved automatic tag attaching apparatus as set forth in detail in the following specification and recited in the annexed claims, taken together with the accompanying drawings, wherein like numerals refer to like parts, and in which:

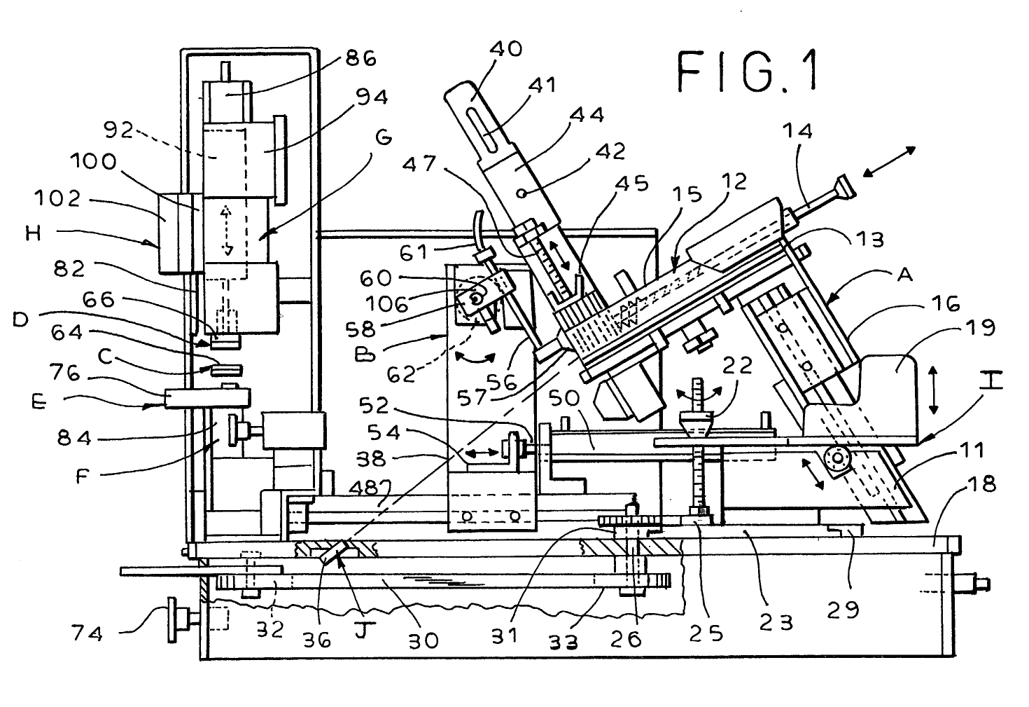

FIG. 1 is a side elevation view of the apparatus of the present invention showing the tag transport means, the clamping means, the fastener dispensing means, and the anvil in their respective initial positions;

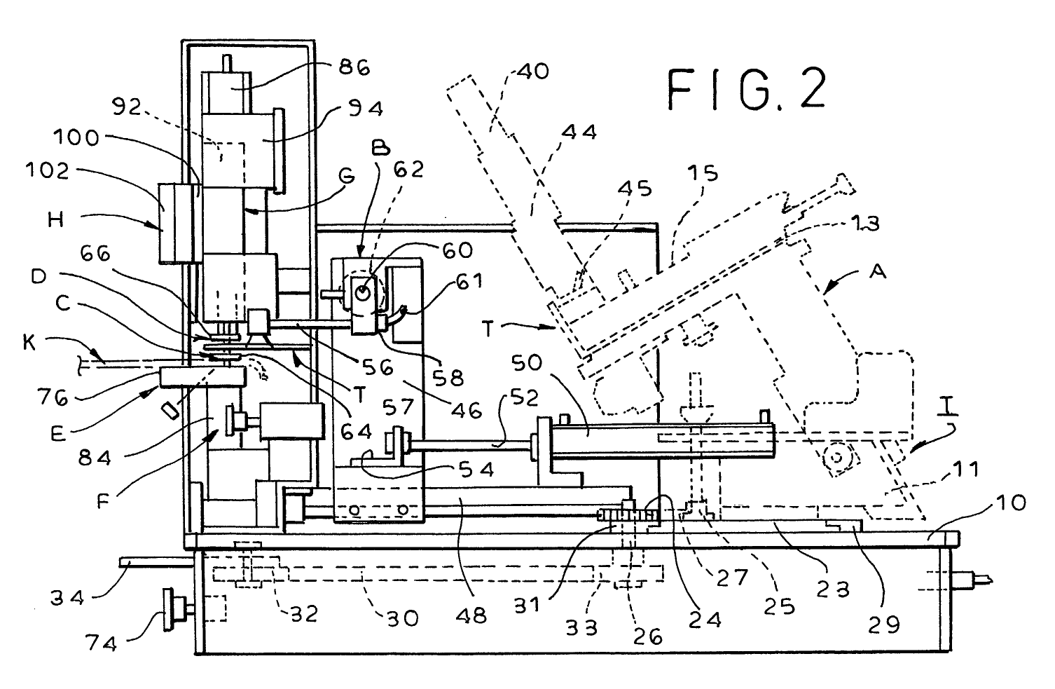

FIG. 2 is a view similar to FIG. 1 but showing the tag transport means, the clamping means, the fastener dispensing means and the anvil in their respective final positions;

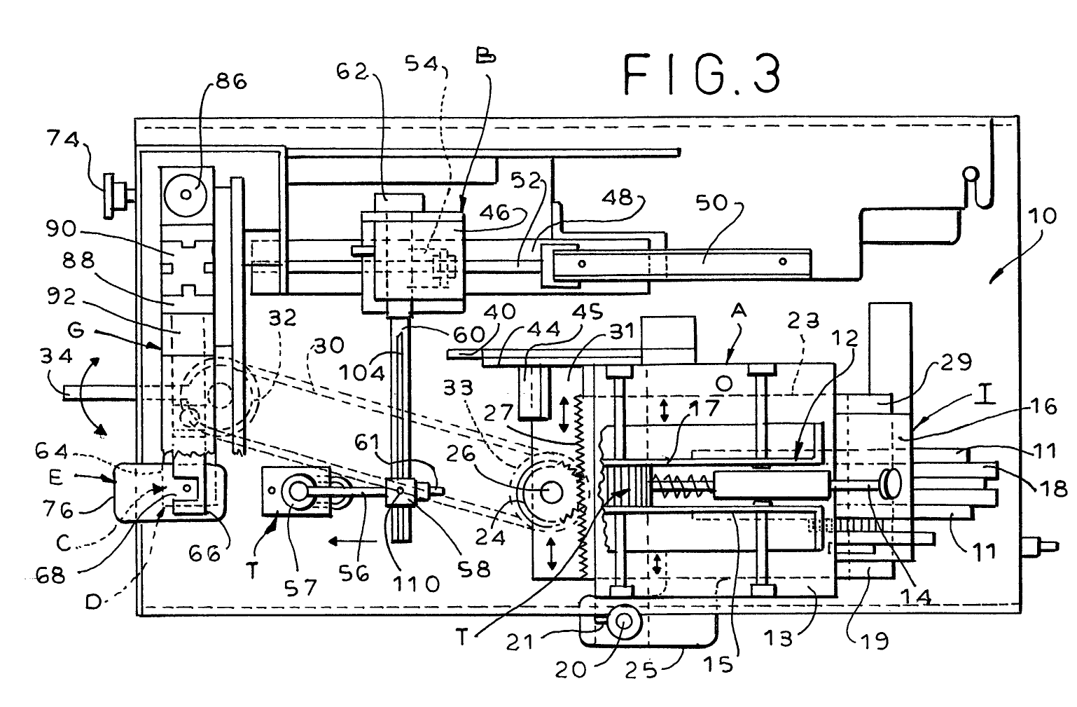

FIG. 3 is a top elevational view of the apparatus showing the tag transport means in an intermediate position and the tag holding means mounting means;

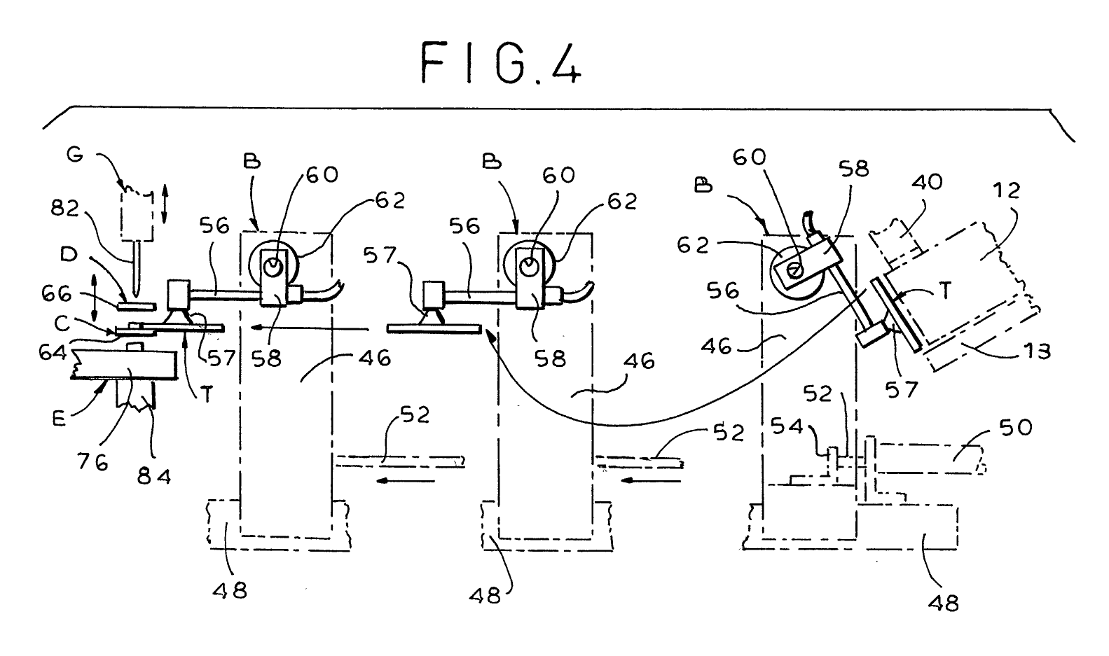

FIG. 4 is a side elevation view showing the initial, intermediate and final positions of the tag transport carriage and vacuum arm;

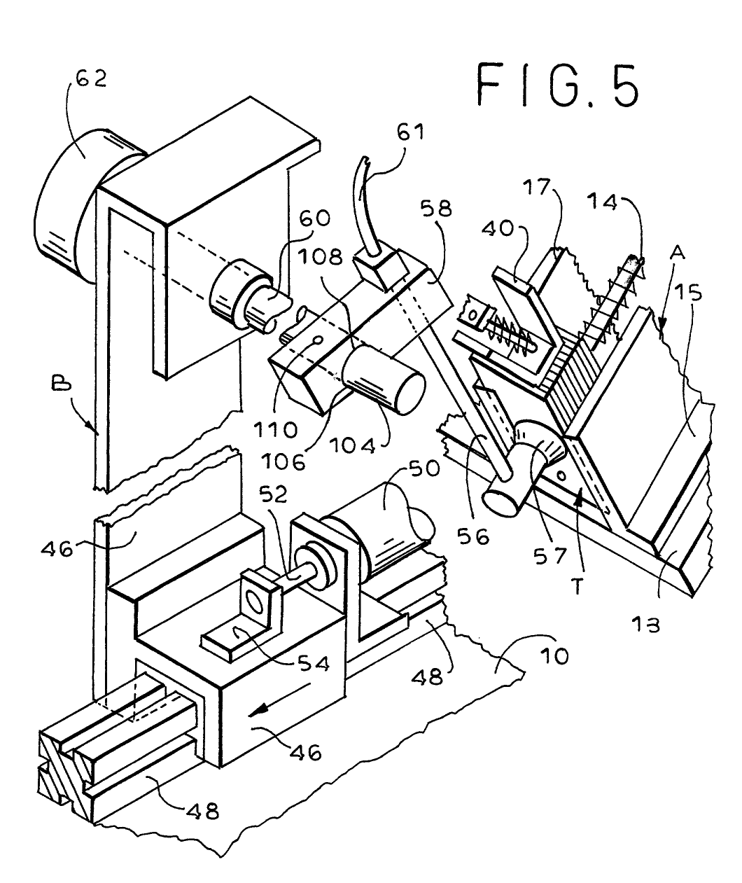

FIG. 5 is an isometric view illustrating the tag transport carriage in greater detail; and

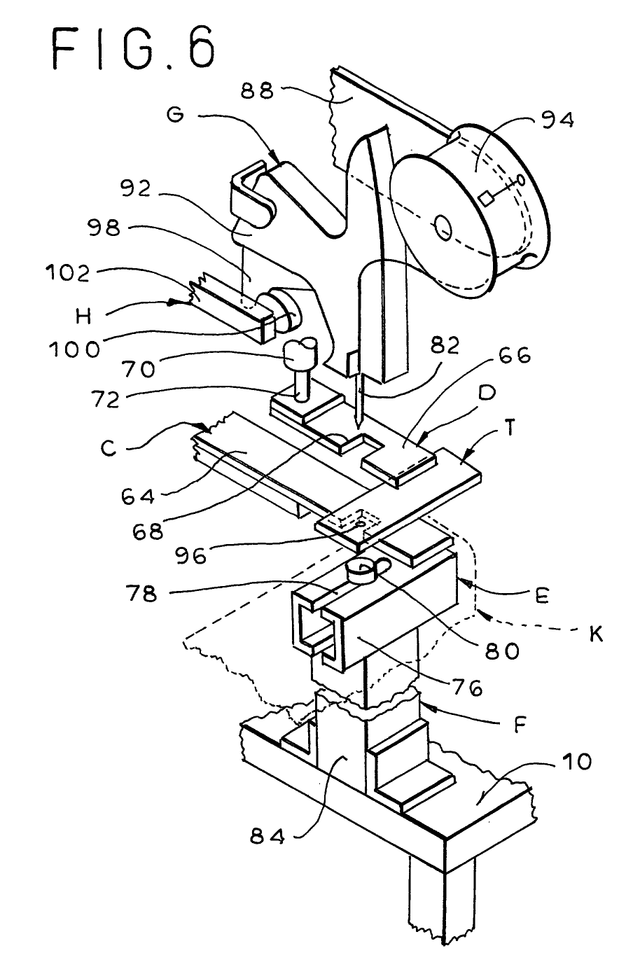

FIG. 6 is an isometric view illustrating the fastener dispensing means, the tag support means, the clamping means and the anvil in greater detail.

As best seen in FIGS. 1 and 2, the automatic tag attaching apparatus of the present invention includes tag holding means, generally designated A, which consists of a position adjustable hopper for retaining a stack of hangtags, generally designated T, each to be affixed to an article, generally designated K. Vacuum tag transport means, generally designated B, removes tags from the tag holding means A, one at a time, and places them on tag support means, generally designated C.

Clamping means, generally designated D, is located above tag support means C, which is stationary. Clamping means D moves downwardly to clamp a tag to the top surface of the tag support means C. Anvil means, generally designated E, is located below tag support means C. It is normally spaced from the undersurface of tag support means C. Means, generally designated F, are provided for moving anvil means E relative to support means C, to hold the article K to the undersurface of tag support means C.

Fastener dispensing means, generally designated G, mounted above clamping means D, includes a housing with a protruding hollow needle through which plastic fasteners are ejected. Means are provided for moving fastener dispensing means G relative to tag support means C, to cause the needle to pass through the tag T and article K. Means, generally designated H, are provided for actuating fastener dispensing means G to dispense a fastener to attach the tag to the article.

Means, generally designated I, are provided for independently adjusting the position of tag holding means A in two directions, horizontally and vertically, relative to the work surface 10. For the purposes of this specification, work surface 10 is assumed to be horizontal and directions are indicated as being relative to the work surface. Laser means, generally designated J, assists in adjusting the position of the tag holding means A.

Tag holding means A consists of a tag hopper mounted at an incline relative to work surface 10. The hopper includes a tray assembly 12 which holds a stack of tags T. The stack is urged toward the open front (left as seen in the drawings) of assembly 12 by a spring loaded rod 14.

As best seen in FIG. 3, tag assembly 12 consists of a platform 13, upon which the stack rests. First and second position adjustable side walls 15, 17 are mounted on platform 13 so as to accommodate different width tags. The front of tray 12 is open, except for inwardly extending lips on sidewalls 15, 17 which retain the tags but permit removal of the tags T, one at a time, through the front of the tray. Assembly 12 is fixed on a “U” shaped bracelet 16 which is slideably received on an elongated track 18. Track 18 is mounted between spaced upstanding parts 11, at an acute angle relative to work surface 10.

Bracket 16 slides along inclined track 18 to adjust the position of tray assembly 12 relative to work surface 10 in a direction perpendicular to the work surface, that is, vertically. Bracket 16 is fixed to a carriage 19 which moves relative to track 18 and has an elongated opening or slot 21 through which an externally threaded screw 20 extends. Situated on screw 20 is an internally threaded part 22 which is rotatably connected to carriage 19. Thus, by rotating part 22, carriage 19, bracket 16 and tray assembly 12 are moved relative to work surface 10. Slot 21 accommodates the horizontal movement of carriage 19 as it moves along inclined track 18. Parts 11, which support track 18, are fixed on a horizontal plate 23.

Screw 20 is fixed on an outwardly extending portion of part 25 bolted to the top surface of plate 23. A rack 27 is fixed to the front of part 25.

Plate 23 is situated on work surface 10 between oppositely oriented upside down “L” shaped parallel spaced brackets 29, 31 such that it can move from side-to-side in a plane parallel to work surface 10 to adjust the position of tray assembly 12 horizontally.

The horizontal adjustment of the position of tray assembly 12 is achieved by rotating pinion gear 24 which engages rack 27. Gear 24 is fixed on a shaft 26 which extends through bracket 31 and work surface 10. Fixed to shaft 26, below work surface 10, is a pully 33.

Connected to pully 33 by a belt 30 is a second pully 32 situated below surface 10 proximate the front end of the apparatus (left as seen in the drawings). Pully 32 is connected to a lever 34 which rotates pully 32 through an arc of about 90°. Moving lever 34 rotates pully 32, moving belt 30 and rotating pully 33 so as to move rack 27, and hence plate 23, from side to side, along work surface 10.

It will now be appreciated that carriage 19 and hence tray assembly 12 is independently position adjustable in the vertical direction, by rotating part 22, and in a horizontal direction, by moving lever 34. This position adjustment of the tray assembly is important because the tags T in the tray assembly must be positioned correctly such that when they are picked up by transport means B and placed on tag support means C, the pre-punched opening in the tags precisely aligns with the needle of fastener dispensing means G.

In order to facilitate positioning of the tray assembly, laser means J, including a laser light 36 is provided. Laser 36 is situated within work surface 10 and, when actuated, generates a thin beam of light 38 which shines on the lead tag in tray assembly 12 at the point where the tag opening should be located such that the opening ends up in alignment with the needle after the tag is placed on the tag support means. By adjusting the position of the tray assembly vertically and horizontally such that the laser beam points directly at the tag opening, the correct position of the hopper assembly is easily achieved.

Platform 13 carries an upstanding bracket arm 40 with an elongated slot 41. A bracket 44 is slideably mounted on arm 40. Bracket 44 carries a screw 42 which extends through slot 41. Loosening the nut on screw 42 permits bracket 44 to be moved along arm 40. Bracket 44 carries a part 45 which abuts the top of the tag stack to maintain the tags in alignment. Part 45 is adjustably mounted to bracket 44 by screw 47. Adjustment of the location of bracket 44 and part 45 permits the tray to accommodate tags of different heights.

Transport means B comprises an upstanding carriage 46 which is movable along a guide 48. Guide 48 is fixed to surface 10. A double acting pneumatic cylinder 50 is provided to move carriage 46. Cylinder 50 has a rod 52 which is connected to carriage 46 by an “L” shaped bracket 54.

Prior to actuation of cylinder 50, rod 52 is in its retracted position, as shown in FIG. 1. Carriage 46 is in its initial position, closest to the tag hopper. Actuation of cylinder 50 causes rod 52 to extend, moving carriage 46 toward tag support means C. Actuating cylinder 50 again causes rod 52 to retract, moving carriage 46 back to its initial position, proximate the tag hopper.

Carriage 46 carries a vacuum arm 56 with a suction cup 57 connected to a vacuum source through line 61. Arm 56 is fixed to a bracket 58. Bracket 58 is slideably mounted on the shaft 60 of a double acting rotating cylinder 62, also pneumatically actuated. Actuating cylinder 62 causes shaft 60 and hence arm 56 to rotate relative to carriage 46 from an initial rotational position, where arm 56 is perpendicular to assembly 12, to a final rotational position, where arm 56 is parallel to the plane in which tag support means B is situated. Actuation of cylinder 62 again causes arm 56 to return to its initial rotational position.

FIG. 4 illustrates the movement of carriage 46 and arm 56. In the initial position, shown at the right in the drawings, carriage 46 is closest to tray assembly 12 Arm 56 is rotated counterclockwise such that suction cup 57 abuts the lead tag in the tray. Actuation of the tag transport means B causes vacuum to be applied to suction cup 57 which engages the lead tag T in tray 12. Cylinder 50 is actuated to move carriage 46 linearly towards its intermediate position. At the same time, cylinder 62 is actuated to rotate arm 56 clockwise, moving tag T through an arc and into a plane which is parallel to the plane of tag support C and perpendicular to the needle of the fastener dispensing device. Hence, the first section of the tag travel path has both linear and arcuate components. Rod 52 of cylinder 50 continues to extend, moving carriage 46 linearly to its final position, right as seen in the drawings, such that tag T is moved in a plane perpendicular to the needle and parallel to work surface 10, and is situated on the top surface of tag support means C, with the opening in the tag aligned with the needle of fastener dispensing means G. Thus, the second portion of the tag transport path is only linear.

Tag T is thus situated on a stationary platform 64, which constitutes tag support means C. Clamping means D, which takes the form of a moveable plate 66, with a needle clearance opening 68, is initially situated above platform 64 and is advanced toward platform 64, into clamping position. Plate 66 is moved by actuation of a double acting pneumatic cylinder 70 (FIG. 6), attached to plate 66 by rod 72. Extension of rod 72 causes plate 66 to clamp the tag to the upper surface of platform 64.

Line 61 to suction cup 57 is now vented, releasing the tag from the tag transport means. Cylinders 50 and 62 are actuated to return the carriage 46 and vacuum arm 56 to their respective initial positions.

In this state, with tag T clamped to the top of platform 64 by plate 66, the apparatus is ready to accept the article K to be tagged. Article K is placed by the operator between platform 64 and hollow rectangular part 76, which forms anvil E, as shown in FIG. 6. Start button 74 is depressed. The depression of button 74 causes a double acting pneumatic anvil moving cylinder (not shown) to move part 76 toward platform 64 to hold article K therebetween. Part 76 has a slot 78 along which a needle receiving cup 80 is slideably mounted. Cup 80 provides clearance for the needle 82 of the fastener dispensing means G, when it is moved toward tag support means C. The anvil cylinder is located within support column 84, upon which part 76 is moveably mounted.

Once part 76 is in its uppermost position, a double acting pneumatic cylinder 86 is actuated to move a bracket 88 down guide 90. Bracket 88 supports fastener dispensing means G which consists of a manually actuated fastener dispensing device with a housing 92 and a roll of fasteners 94. Housing 92 carries a hollow slotted needle 82 which extends from the front thereof.

As housing 92 is moved toward support platform 64 to which tag T is clamped by plate 66, needle 82 passes through clearance opening 68 in plate 66, through the pre-punched opening 96 in tag T, through clearance opening 65 in support platform 64, penetrates article K and is received in cup 82 on anvil part 76. As housing approaches the end of its downward movement, gun trigger 98 bears against wheel 100 rotatably mounted on a fixed bracket 102 (see FIG. 6) such that trigger 98 is depressed and a fastener is ejected through needle 82.

After the fastener is ejected, cylinder 86 is actuated to move housing 92 upwardly, away from support plate 64, the anvil cylinder is actuated to move anvil part 76 downwardly away from support platform 64 and clamping cylinder 70 is actuated to move clamping plate 66 away from support platform 64. The tagged article K can now be removed from the apparatus.

At this point in time, the vacuum in line 61 to suction cup 57 is turned on, the next tag on tray assembly 12 is engaged and the transport means B is actuated as described above such that the engaged tag is placed on support platform 64. Plate 66 is moved to clamp the tag on support platform 64, the vacuum to suction cup 57 is vented and the tag transport means returns to its initial position. The operator inserts the next article K to be tagged between anvil part 76 and support platform 64 and pushes button 74 to repeat the tagging cycle.

It is important that suction cup 57 be properly positioned with respect to the lead tag in tray 12 to insure that the tag will be properly engaged by the suction cup. This is accomplished by “keying” arm bracket 58 on to cylinder shaft 60 such that the suction cup is in a plane parallel to the plane of the lead tag.

As best seen in FIGS. 3 and 5, shaft 60 is provided with a slot 104 which receives a protrusion 106 situated within an opening 108 in bracket 58 through which shaft 60 extends. Thus, the rotational position of shaft 60 (and hence vacuum arm 56) on bracket 58 is always fixed, although the distance between bracket 58 and carriage 46 can be adjusted to accommodate a change in the horizontal position of the tag hopper by loosening a set screw 110 on bracket 58 and sliding bracket 58 along shaft 60.

It will now be appreciated that the automatic tag attaching device of the present invention includes a number of improvements over currently available machines. Vacuum transport means which moves through a simplified path are utilized. The transport means simply places the tag on a stationary support platform. The fastener dispensing device is advanced relative to the tag support platform to cause the needle to penetrate the tag and article. This eliminates the necessity of having to place the tag over a stationary needle by a complicated movement of the vacuum arm.

The tag hopper is independently position adjustable in horizontal and vertical directions. Positioning of the tag hopper is facilitated through use of a laser beam. This makes set up much easier and reduces machine down time when switching tag sizes.

The vacuum arm is keyed to the transport carriage. In this way, the suction cup is always in the correct plane, relative to the lead tag in the tag hopper.

While only a single preferred embodiment of the present invention has been disclosed for purposes of illustration, it is obvious that many modifications and variations could be made thereto. It is intended to cover all of these modifications and variations which fall within the scope of the present invention, as defined by the following claims:

### We claim:

1. Automatic apparatus for attaching tags to articles comprising means for holding a plurality of tags, tag support means spaced from said tag holding means, vacuum tag transport means for removing tags, one at a time, from said tag holding means and placing them on said tag support means, means for clamping the tag on said tag support means, the article to be tagged being situated proximate to said tag support means, fastener dispensing means comprising a hollow needle through which fasteners are ejected, means for moving said fastener dispensing means relative to said tag support means to cause said needle to pass through the tag and article, and means for actuating said fastener dispensing means.

2. The apparatus of claim 1 further comprising anvil means normally spaced from said tag support means.

3. The apparatus of claim 2 further comprising means for advancing said anvil means towards said tag support means to hold the article therebetween.

4. The apparatus of claim 3 wherein said anvil advancing means is actuated before said fastener dispensing means.

5. The apparatus of claim 2 wherein said anvil means comprises a needle receiving recess.

6. The apparatus of claim 1 wherein said tag transport means moves a tag through a first path section, wherein the tag is moved to a plane substantially perpendicular to said needle and then through a second path section, wherein the tag is moved substantially within said perpendicular plane, into alignment with said tag support means.

7. The apparatus of claim 1 wherein said tag transport means comprises a linearly moveable carriage, an arm with a suction cup and means for rotatably mounting said arm on said carriage.

8. The apparatus of claim 7 wherein said arm mounting means comprises means for keying said arm to said carriage such that said suction cup is coplanar with the lead tag in said tag holding means, when the tag is engaged by the suction cup.

9. The apparatus of claim 1 further comprising a work surface and means for position adjustably mounting said tag holding means on said work surface for independent positioning in two directions.

10. Automatic apparatus for attaching tags to articles comprising means for holding a plurality of tags, tag support means spaced from said tag holding means, tag transport means for removing tags, one at a time, from said tag holding means and placing them on said tag support means, fastener dispensing means comprising a hollow needle through which fasteners are ejected, means for moving said fastener dispensing means relative to said tag support means to cause said needle to pass through the tag on said tag support means and means for actuating said fastener dispensing means, said tag transport means comprising means adapted to engage a tag in said tag holding means, and means for moving said tag engaging means through a first path section, wherein the engaged tag is situated in a plane substantially perpendicular to said needle, and then through a second path section, wherein the engaged tag is moved along said perpendicular plane, into alignment with said tag support means.

11. The apparatus of claim 10 wherein said tag support means is situated in a plane substantially perpendicular to said needle.

12. The apparatus of claim 10 wherein said second path section is substantially parallel to the plane of said tag support means.

13. The apparatus of claim 10 wherein said fastener dispensing means moves in a direction substantially perpendicular to said tag support means.

14. The apparatus of claim 10 wherein said tag transport means comprises a carnage, an arm upon which said tag engaging means is situated and means for rotatably mounting said arm on said carriage.

15. The apparatus of claim 14 wherein said arm mounting means comprises means for keying said arm to said carriage such that said tag engaging means aligns with the lead tag in said tag holding means, when the tag is engaged.

16. The apparatus of claim 10 wherein said tag engaging means comprises a suction cup.

17. The apparatus of claim 10 further comprising a work surface and means for position adjustably mounting said tag holding means on said work surface for independent positioning in two directions.

18. The apparatus of claim 17 further comprising laser means for positioning said tag holding means mounting means.

19. The apparatus of claim 10 further comprising means for clamping a tag to said tag support means.

20. Automatic apparatus for attaching tags to articles comprising a work surface, means, mounted on said work surface, for holding a plurality of tags, tag support means spaced from said tag holding means, tag transport means for removing tags, one at a time, from said tag holding means and placing them on said tag support means, fastener dispensing means comprising a hollow needle through which fasteners are ejected, means for moving said fastener dispensing means relative to said tag support means to cause said needle to pass through the tag on the tag support means, means for actuating said fastener dispensing means, and means for mounting said tag holding means on said work surface for independent position adjustment in two directions relative to said work surface.

21. The apparatus of claim 20 wherein said two directions are substantially parallel to said work surface and substantially perpendicular to said work surface, respectively.

22. The apparatus of claim 20 wherein said mounting means comprises a rack on said tag holding means and a pinion gear rotatably mounted on said work surface.

23. The apparatus of claim 20 wherein said mounting means comprises a threaded shaft perpendicular to said work surface and an internally threaded part connected to said tag holding means, said part being rotatably received on said shaft.

24. The apparatus of claim 20 wherein said fastener dispensing means moving means moves said fastener dispensing means in one of said directions.

25. The apparatus of claim 24 wherein said tag transport means moves tags in the other of said directions.

26. The apparatus of claim 20 wherein said tag transport means moves a tag through a first path section, wherein the tag is situated in a plane substantially perpendicular to said needle, and then through a second path section, wherein the tag is moved substantially within said perpendicular plane, into alignment with said tag support means.

27. The apparatus of claim 26 wherein said second path section is in one of said directions.

28. The apparatus of claim 20 further comprising laser means for positioning said tag holding means mounting means.

29. The apparatus of claim 20 wherein said tag transport means comprises a linearly moveable carriage, an arm with a suction cup and means for rotatably mounting said arm on said carriage.

30. Automatic apparatus for attaching tags to articles comprising means for holding a plurality of tags, tag support means spaced from said tag holding means, tag transport means for removing tags, one at a time, from said tag holding means and placing them on said tag support means, fastener dispensing means comprising a hollow needle through which fasteners are ejected, means for moving said fastener dispensing means relative to said tag support means to cause said needle to pass through the tag on said tag support means and means for actuating said fastener dispensing means, said tag transport means comprising a moveable carriage, an arm carrying a suction cup adapted to engage a tag in said tag holding means, and means for mounting said arm on said carriage such that said suction cup is aligned with the lead tag in said tag holding means, when the tag is engaged by said suction cup.

31. The apparatus of claim 30 wherein said tag transport means moves a tag through a first path section, wherein the tag is situated in a plane substantially perpendicular to said needle and then through a second path section, wherein the tag is moved substantially within said perpendicular plane, into alignment with said tag support means.

32. The apparatus of claim 31 wherein said first path section is arcuate.

33. The apparatus of claim 31 wherein said second path section is only linear.

34. The apparatus of claim 30 wherein said tag transport means comprises a linearly moveable carriage to which said arm is rotatably mounted.

35. The apparatus of claim 30 further comprising a work surface and means for position adjustably mounting said tag holding means on said work surface for independent positioning in two directions.

36. The apparatus of claim 35 further comprising laser means for positioning said tag holding means mounting means.

37. The apparatus of claim 30 wherein said arm mounting means comprises a shaft, a bracket to which said arm is mounted, said bracket having an opening through which said shaft extends, said opening being defined in part by a protrusion, said shaft having a slot, said protrusion being slideably received in said slot.

38. The apparatus of claim 37 further comprising a cylinder with rotatable rod and whereas said shaft comprises said rotable rod.

39. The apparatus of claim 37 wherein said bracket is slideably received on said shaft.

40. Automatic apparatus for attaching tags to articles comprising a work surface, means, for holding a plurality of tags, each of the tags having an opening, means for position adjustably mounting said tag holding means on said work surface, tag support means spaced from said tag holding means, tag transport means for removing tags, one at a time, from said tag holding means and placing them on said tag support means, fastener dispensing means comprising a hollow needle through which fasteners are ejected, means for moving said fastener dispensing means relative to said tag support means to cause said needle to pass through the opening in the tag on said tag support means, means for actuating said fastener dispensing means, and laser means for positioning said tag holding means relative to said work surface such that said tag transport means places each tag on said tag support means with said opening of the tag in alignment with said needle.

41. The apparatus of claim 40 wherein said tag transport means moves a tag through a first path section, wherein the tag is situated in a plane substantially perpendicular to said needle and then through a second path section wherein the tag is moved substantially within said perpendicular plane, into alignment with said tag support means.

42. The apparatus of claim 41 wherein said first path section is arcuate.

43. The apparatus of claim 41 wherein said first path section is arcuate has a component and a linear component.

44. The apparatus of claim 41 wherein said second path section is only linear.

45. The apparatus of claim 40 wherein said tag transport means comprises a linearly moveable carriage, an arm with a suction cup, and means for rotatably mounting said arm on said carriage.

46. The apparatus of claim 45 wherein said arm mounting means comprises means for keying said arm to said carriage such that said suction cup is aligned with the lead tag in said tag holding means, when the tag is engaged by the suction cup.

47. The apparatus of claim 40 wherein said means for position adjustably mounting said tag holding means on said work surface independently positions said tag holding means in two directions.
